(19) United States
(12) Patent Application Publication
(10) Pub. No.: US 2024/0060645 A1
(43) Pub. Date: Feb. 22, 2024

(54) COMBUSTOR SYSTEMS AND METHODS

(71) Applicant: University College Cardiff Consultants Limited, Cardiff (GB)

(72) Inventor: Agustin Valera Medina, Cardiff (GB)

(21) Appl. No.: 18/035,955

(22) PCT Filed: Nov. 3, 2021
(86) PCT No.: PCT/GB2021/052839

§ 371 Date: May 9, 2023

(30) Foreign Application Priority Data
Nov. 12, 2020 (GB) 2017854.7

(51) Int. Cl. F23R 3/36; F23R 3/34; F23R 3/16; F23R 3/00

(52) U.S. Cl. CPC F23R 3/36; F23R 3/346; F23R 3/16; F23R 3/005

(57) ABSTRACT

System comprising a gas turbine engine fuel injection apparatus (11) arranged to deliver to a combustion chamber (9) of a gas turbine engine a first injection fluid comprising a first fuel and a second injection fluid comprising a second fuel. The apparatus is arranged to deliver the first and second injection fluids in a manner such that the first injection fluid is delivered in a first stream and the second injection fluid is delivered in a second stream. Further, such that there is a delivery zone (47) corresponding to a first location at which both the first and second streams have been delivered in which the first stream is substantially radially surrounded by the second stream.

### TECHNICAL FIELD

The present disclosure relates to combustor systems and methods. Aspects of the invention relate to a system comprising a fuel injection apparatus, gas turbine engines, a method of injection fuel in a gas turbine engine and a gas turbine engine fluid system. The disclosures may be particularly, but not exclusively, applicable to combustors arranged to be fuelled at least in part by ammonia fuel. The disclosures may be particularly applicable to combustors used in gas turbine engines or boilers for use in the field of power generation, though they also are relevant to other fields (e.g. marine, aerospace and train applications).

### BACKGROUND

This background section is provided in the context of ammonia fuelled gas turbine engines, but this is for convenience only and it will be appreciated that the technology disclosed has application in alternative systems.

In terms of environmental impact, use of ammonia as a fuel (e.g. in gas turbine engines) has potential benefits by comparison with carbon-based fuels such as kerosene and fuel oil. Specifically, ammonia combustion with air produces nitrogen and water rather than carbon dioxide and water. Nonetheless, ammonia does present other challenges. It's combustion in air produces nitrogen oxides (an undesirable emissions product) and it hardly combusts in air. The latter problem may be overcome by using an additional fuel such as hydrogen to assist in creating ignition of the ammonia. This however may exacerbate the production of nitrogen oxides because hydrogen can burn in air at high temperatures to produce nitrogen oxides and water. Storing a second fuel such as hydrogen also adds additional complexity and hazards.

### SUMMARY OF THE INVENTION

According to a first aspect of the invention there is provided a system optionally comprising a gas turbine engine fuel injection apparatus optionally arranged to deliver to a combustion chamber of a gas turbine engine a first injection fluid optionally comprising a first fuel and a second injection fluid optionally comprising a second fuel, the apparatus optionally being arranged to deliver the first and second injection fluids in a manner such that the first injection fluid is delivered in a first stream and the second injection fluid is delivered in a second stream and optionally such that there is a delivery zone corresponding to a first location at which both the first and second streams have been delivered optionally in which the first stream is substantially radially surrounded by the second stream.

The use of multiple different fuels for combustion may be desirable where for instance the different fuels offer different performance and/or characteristics. By way of example, one fuel may offer better efficiency, easier or safer storage, may be more readily available and/or may give rise to fewer or less polluting emissions, but may combust less readily than another fuel. The latter fuel which combusts more readily may therefore be burned to create sufficient temperature to ignite the fuel which combusts less readily. Thus benefit may arise by combusting the fuels in such a combination.

By delivering the injection fluids and therefore the fuels in the stratified/layered manner described above, reaction of delivered species in the injection fluids may be permitted to occur at different rates and/or temperatures, potentially allowing control over completeness of combustion, reactions occurring and/or emissions composition. For instance, reaction products from hotter combustion (occurring nearer to the core of a flame) of the first fuel in the first stream may react further with unburnt second fuel in the second stream, potentially thereby removing undesirable combustion products and thereby reducing undesirable emissions. The availability of unburnt second fuel for this purpose may be increased as a consequence of the second stream being located radially outwards from the first stream, further from the hotter core of the flame, potentially resulting in less of it combusting. By way of further example, the presence of the second stream surrounding the first stream may mean that the reaction products from combustion of the first fuel are at least partially constrained by and are more likely to react with the surrounding second fuel of the second stream. By way of still further example, the first stream (being radially inward) may tend to follow a more direct path through an associated combustor than the second stream (being radially outward) which may be more likely to be recirculated within the combustor. This may be advantageous where it is desired that a significant proportion of the first fuel is combusted in one or more downstream combustion processes at lower temperatures. Furthermore, by injecting the injection fluids and ultimately therefore the fuels in separate streams, rather for instance than in a mixed flow, more precise metering of the fuels may be achieved, allowing better control of ignition stages and combustion processes.

In some embodiments the apparatus is arranged to deliver the first and second streams in substantially the same direction. This direction may for instance be an axial direction e.g. with respect to a combustor in which the fuel injection apparatus is arranged to be provided and/or a gas turbine engine in which the fuel injection apparatus is arranged to be provided. This may facilitate the first and second streams being delivered in close proximity with the first stream surrounded by the second stream. The common direction may also facilitate particular flow characteristics at and downstream of the delivery zone.

In some embodiments the first and second streams are delivered from separate respective first and second outlets. The second outlet may substantially surround the first outlet and may immediately surround it. Additionally or alternatively the outlets may be adjacent.

In some embodiments the first outlet is angled with respect to a radial plane such that it is arranged to direct the first injection fluid stream into the second injection fluid stream. The first outlet may therefore be angled with respect to both radial and axial planes. The angled nozzle may deliver the first fuel of the first injection fluid for stoichiometric combustion, thus raising temperature. Additionally, it may tend to bend the flame away from an axial orientation which may be advantageous in terms of recirculation of reactants within the combustion chamber.

In some embodiments the first and second outlets are substantially concentric. In this manner a uniform flow of the first and/or second injection fluids may be obtained regardless of the angular direction.

In some embodiments the first outlet has an annular cross-section. This may allow for at least one further outlet to be located radially inwards of the first outlet for delivery of additional fluid to the delivery zone and/or combustion chamber.

In some embodiments the second outlet has an annular cross-section. This may facilitate locating of the first outlet radially inwards of and surrounded by the second outlet.

In some embodiments the system comprises an air outlet, radially inward of and radially surrounded by the first outlet, arranged to deliver air for combustion with the first and second fuels once delivered. The air outlet may have a circular cross-section.

In some embodiments the first outlet and the air outlet may be provided in a burner head.

Each of the outlets discussed above may be axially aligned with one or both other of the outlets or may be axially spaced from one or both other of the outlets. Each outlet may be continuous or may comprise a plurality of discrete openings.

In some embodiments the apparatus comprises a first passage through which the first injection fluid is delivered to the first outlet. The first passage may be annular in cross-section.

In some embodiments the apparatus comprises a second passage, radially outward of and radially surrounding the first passage, through which the second injection fluid is delivered to the second outlet. The second passage may be annular in cross-section.

In some embodiments the second passage comprises an angular swirler arranged to provide the second injection fluid with a tangential swirl for its delivery from the second outlet. This swirl may allow improved control over mixing and interaction of the first and second streams, which may in turn provide control over reaction rates between chemical constituents of the first and second streams and potentially therefore emission composition.

In some embodiments the system comprises a supplementary fuel outlet in the second passage arranged to deliver a supplementary fuel to the remainder of the second injection fluid prior to its delivery to the combustion chamber by the apparatus. This may allow for enhanced mixing of the supplementary fuel with the remainder of the second injection fluid. The supplementary fuel outlet may be downstream of the angular swirler because this may help to prevent flash-back of the supplementary fuel. The supplementary fuel may be a reactant with higher reaction rate than the second fuel such as hydrogen gas and/or methane gas which may serve to aid in combustion of the second fuel in the combustion chamber.

In some embodiments the system comprises a supplementary fuel passage through which the supplementary fuel is delivered to the supplementary fuel outlet. The supplementary fuel passage may be provided between the first passage and the second passage.

In some embodiments the system comprises a heating fluid chamber arranged such that a heating fluid in the heating fluid chamber is in thermal contact with the second injection fluid in the second passage, to control the temperature of the second injection fluid. The thermal energy of the heating fluid may be generated by the combustion of the first and second fuels in the combustion chamber. The heating fluid may for instance be water and/or steam.

In some embodiments the system comprises an air passage radially inward of and radially surrounded by the first passage, through which the air is delivered to the air outlet. The air passage may be circular in cross-section.

In some embodiments the air passage comprises an axial swirler arranged to provide the air with an axial swirl for its delivery from the air outlet. Axial swirl in the air delivered from the air outlet may help to stabilise a small, central flame in the delivery zone burning at least a part of the first injection fluid e.g. the first fuel. Additionally, it may give rise to recirculation at and/or in the proximity of the delivery zone, by causing the ignited first fuel of the first injection fluid to swirl, which in turn gives rise to recirculation in the vicinity of the delivery zone via vortex breakdown. This may increase the dwell time of the first fuel in the vicinity of the delivery zone, increasing the completeness of its combustion at this (rather for instance than a later stage) which may have advantageous effects in terms of likelihood of the reduction of the products of this combustion process via reaction with unburned constituents of the second injection fluid.

In some embodiments initial combustion of at least part of the first injection fluid in the first stream serves as a pilot for ignition of at least part of the second injection fluid in the second stream.

In some embodiments one of the first and second fuels comprises a slower reacting fuel and the other comprises a faster reacting fuel. The slower reacting fuel may be a fuel which does not combust readily in air and/or will combust in air only in a significantly reduced range of conditions (e.g. temperatures) by comparison with the faster reacting fuel. Under at least some of the conditions which would prevail in the combustion chamber without the presence of the faster reacting fuel, it may be that the slower reacting fuel is of a type that would not combust. The presence and nature of the faster reacting fuel may therefore allow for the combustion of the slower reacting fuel. The difference in the reaction rate of the first and second fuels may result from the chemical constituents of the respective fuels, i.e. the first and second fuels being of different chemical composition (rather for instance than the phase of the respective fuels). The slower reacting fuel may for instance be ammonia gas and/or the faster reacting fuel may for instance be hydrogen gas and/or methane gas.

In some embodiments the first fuel comprises the faster reacting fuel and the second fuel comprises the slower reacting fuel. This combination may complement the system architecture. Specifically the slower reacting fuel, in the radially outer second stream may in part be separated from the hot core of the combustion flame, which may mean that a significant proportion of it may remain unburned. At least with sufficient re-circulation within the combustor, this unburned slower reacting fuel may react with undesirable combustion products of the overall combustion process occurring towards the centre of the combustion flame. Further, the delivery of the slower reacting fuel in a stream surrounding the stream of faster reacting fuel may tend to trap combustion products from combustion of the latter, increasing the reaction of those products with the faster reacting fuel. Where for instance the faster reacting fuel is hydrogen gas and the slower reacting fuel is ammonia gas or an ammonia blend, the central combustion of the hydrogen may give rise to NOx, which is undesirable in emissions. The NOx may however react with unburned ammonia, formed radicals and/or other species surrounding it and or re-circulated with it to produce nitrogen gas and steam. Further, NOx produced by the combustion of ammonia can also be reduced by surrounding radicals at the point of contact between the first and second injection fluids. Still further, with the faster reacting fuel e.g. hydrogen delivered in a central stream, it may tend to follow a more direct path (i.e. be less likely to be circulated than the surrounding layer of including the slower reacting fuel) to any downstream areas of the combustion process. Where for instance this includes a flameless combustion zone, it may be desirable to deliver as directly as possible a significant proportion of the faster reacting fuel to this zone for combustion, where the combustion conditions may be less likely to give rise to undesirable emissions.

In some embodiments the second fuel further comprises a faster reacting fuel which may be the supplementary fuel. This may be the same as the faster reacting fuel of the first fuel. The provision of the faster reacting fuel in the second fuel may assist in combustion of the slower reacting fuel in the combustion chamber.

In some embodiments the second injection fluid additionally comprises one or more other constituents. These other constituents may for example be provided for use in combustion (e.g. air), for reaction with combustion products and/or to increase the mass of fluid within the combustor e.g. steam and/or to control the rate of combustion and/or reaction.

In some embodiments the delivery zone is radially surrounded and defined by a Coanda generating body.

In some embodiments the Coanda generating body comprises a tubular portion radially surrounding the apparatus having a radially inner surface of consistent cross-section and connected thereto a flared portion downstream of the tubular portion. The tubular portion may be substantially cylindrical. The Coanda generating body (and in particular the tubular portion) may assist in protecting the initial flame and commencement of combustion from turbulent flows. The Coanda generating body (and in particular the flared portion) may help to provide initial direction to the first and second streams to aid in the generation of re-circulating flows within the combustor.

In some embodiments the flared portion comprises a continuously tapering portion connected to the tubular portion having a radially inner surface with a progressively expanding cross-section in a downstream direction. This may create a zone of low pressure tending to bend the initial flow from the apparatus so as to have a greater component in the radially outer direction. It may therefore be considered that the flame is flattened. This may tend to cause the initial flow to eventually reach a side wall of the combustion chamber whereupon part of the flow may be turned to travel in a downstream direction and part in an upstream direction. The downstream part may ultimately be in part recirculated by being further turned and travelling down the centre of the combustion chamber. The upstream part may tend to form and be trapped in a vortex surrounding the Coanda generating body. The recirculation may increase residence time, potentially improving completeness of combustion and/or opportunity for undesirable combustion products to react further. The recirculation may also reduce the combustion temperature, especially by the control of temperature produced by heat transfer processes involving another fluid, e.g. steam, which may be desirable and conducive to flameless combustion. The flattening of the flame may also serve to direct it away from the burner head, potentially thereby reducing damage to the burner head over time and thereby reducing maintenance requirements.

In some embodiments the radially inner surface of the tubular portion and the radially inner surface of the continuously tapering portion meet at a discontinuity in the form of an edge. This may assist in producing a small toroidal region of low pressure downstream of the edge.

In some embodiments the flared portion comprises a rim portion connected to the continuously tapering portion having a downstream surface extending in a substantially radial direction. The rim portion may create a further low pressure zone to further bend the initial flow from the apparatus so as to have a greater component in the radially outer direction. This may therefore assist in producing the recirculation processes described above.

In some embodiments the radially inner surface of the continuously tapering portion and the downstream surface of the rim portion meet at a discontinuity in the form of an edge. This may assist in producing a small toroidal region of low pressure downstream of the edge.

In some embodiments the Coanda generating body extends into the combustion chamber defined by a combustor can, forming a vortex region bounded radially by a radially outer surface of the Coanda generating body and a radially inner surface of the combustor can and bounded axially by an upstream surface of the combustor can. This vortex region may be considered a trapped vortex region. Fluid delivered by the apparatus and travelling with a radially outward component may reach a side wall of the combustor can and in part may be directed in an upstream direction. Thereafter the flow may be turned again first by an upstream wall of the combustor can and then by the radially outer surface of the Coanda generating body. This flow may tend to form a vortex in the vortex region. The vortex region may be arranged to be conducive to the formation of the vortex. Thus for instance, the walls and surfaces described may be at least substantially uninterrupted and/or continuous. Further, it may be that injection of other material e.g. fuel, air etc in the vortex region is omitted, so as not to disturb the formation of the vortex. It may be that in the system, the only fuel injected is via the first and second streams. The vortex may increase residence time, at controllable temperatures. Further, the vortex may tend to increase completeness of combustion and/or opportunity for further reaction of undesirable combustion products. As will be appreciated, the combustor can may be substantially cylindrical.

In some embodiments an upstream wall of the combustor can has a form arranged to increase its surface area by comparison with a flat plate like form. It may for instance comprise formations in its structure such as undulations (e.g. corrugations, castellations, channels or peaks and troughs) or fins. This may facilitate increased thermal energy transfer between fluids in the combustion chamber and the heating fluid chamber, where the heating fluid chamber is appropriately positioned (e.g. adjacent and/or in thermal contact with the upstream wall of the combustor can). It should be noted that the heating fluid chamber may be so positioned regardless of the form of the upstream wall of the combustor can. Thermal transfer between the heating fluid in the heating fluid chamber and fluid in the combustion chamber may serve to cool the fluid in the combustion chamber and particularly that in the vortex region. This may be conducive to further reaction of combustion products which may themselves be undesirable as emissions. The form may additionally or alternatively increase the strength of the upstream wall for a given weight of material.

In some embodiments the upstream surface of the combustor can comprises undulations. The undulations may be arranged such that each of a peak and a trough of each undulation extends in a radial direction. The undulations may be provided in a repeating pattern or may be irregular. Such undulations may serve to further assist in formation of vortex in the fluid in the vortex region. As will be appreciated the undulations may be created by and/or may indeed be the formations which increase the surface area as described above.

In some embodiments the upstream surface of the combustor can may be canted and/or sloped with respect to the radial direction such that the upstream surface moves further downstream from a radially outer to radially inner direction. Where the upstream surface is canted it may form an angle between approximately 15 and 60 degrees with a radial plane.

In some embodiments water and/or steam may be injected into the vortex region through one or more ports in the upstream wall of the combustor can. Steam injected in this manner may serve in particular to reduce the temperature of fluid in the vortex region, which may be conducive to further reaction of combustion products which themselves may be undesirable as emissions. The ports may be arranged to inject the water and/or steam in a direction substantially perpendicular to the upstream surface of the combustor can at the location of the port position. This may assist in forming fluid within the vortex region into a vortex.

In some embodiments the outer surface of the Coanda generating body has a substantially concave shape. The radially outer surface may for instance be substantially parallel at respective corresponding locations to the radially inner surface of the tubular portion, the radially inner surface of the continuously tapering portion and/or the downstream surface of the rim portion to the extent that each are provided. In this way the outer surface of the Coanda generating body may encourage formation of a vortex in the vortex region through suitable re-directing incident fluid flow.

In some embodiments the combustor can has a waist portion in which its radially inner surface is tapered to a reduced diameter and the waist portion is located in terms of its position along the combustor can so as to substantially intersect fluid flow travelling downstream from the assembly and re-directed by the Coanda generating body to increase a component of its direction of travel which is towards the radially inner wall of the combustor can. The waist may tend to encourage the redirection at the combustor can side wall of the flow from the assembly into flows travelling downstream to ultimately be recirculated and upstream to ultimately form the vortex.

In some embodiments the combustion chamber comprises a primary combustion zone in which rich combustion occurs which is downstream of the apparatus and a secondary combustion zone in which flameless combustion occurs which is downstream of the primary combustion zone. The secondary combustion zone may be immediately downstream of the primary combustion zone. The secondary combustion zone may have elevated humidity levels and/or higher fuel dilution in combustion products and/or other reaction products and/or further fluid components by comparison with the primary combustion zone. Combustion may occur in the secondary combustion zone at temperatures substantially at or below 1300K. Due to lower temperatures, flameless combustion may be conducive to reduced production of undesirable emission products, especially when burning a faster reacting fuel such as hydrogen, which may be the first fuel and traces from rich combustion of the second fuel.

In some embodiments the combustor can comprises at least one air inlet in or adjacent the secondary combustion zone, the at least one air inlet being arranged to deliver additional air into the combustion chamber. The at least one air inlet may be located proximate the commencement of the secondary combustion zone. The at least one air inlet may be arranged to generate axial-tangential swirl, which may promote mixing and residence time for more complete combustion as well as increasing stability. This delivery of air may facilitate dilution of the first and second fuel present in the secondary combustion zone, allowing for combustion in a discreet mode, potentially facilitating flameless combustion.

In some embodiments the combustor can comprises at least one nitrogen inlet in or adjacent the secondary combustion zone, the at least one nitrogen inlet being arranged to deliver nitrogen into the combustion chamber. The at least one nitrogen inlet may be located proximate the commencement of the secondary combustion zone. The at least one nitrogen inlet may be arranged to generate axial-tangential swirl which may promote mixing and residence time for more complete combustion as well as increasing stability. The injection of nitrogen in this manner may reduce the reactivity and temperature in the secondary combustion zone, further promoting the correct conditions for flameless combustion and/or generating more stable expansion in a turbine downstream of the combustor. The nitrogen delivered may be sourced from a cracker located inside the combustion chamber (discussed further below).

As will be appreciated, the at least one air inlet and the at least one nitrogen inlet may be a combined air and nitrogen inlet.

In some embodiments the combustion chamber comprises a baffle between the primary and secondary combustion zones which reduces the cross-sectional area of the combustion chamber and thereby creates a flow constriction for fluid passing from the primary combustion zone to the secondary combustion zone. The baffle may be substantially centrally located within the combustion chamber in a radial sense, defining a passage between the primary and secondary combustion zones around its periphery. The passage may for instance be annular. The baffle may have a prominence facing in an upstream direction which may have a central apex. The baffle may for instance be domed, be a cone, be a cone frustrum, be an ovoid or be spherical. The baffle may assist in creation of recirculation within the primary combustion zone. Specifically it may assist in turning flow travelling in a downstream direction towards the radial extremities of the combustion chamber, such that it travels upstream nearer to the centre of the combustion chamber.

In some embodiments a cracker is located within the combustion chamber arranged to provide thermal contact between combusting fluid in the combustion chamber and a first cracker fluid undergoing a first process passing through a first channel within the cracker to thereby chemically decompose the first cracker fluid into two or more chemical species. By positioning the cracker inside the combustion chamber, the necessary heat for the decomposition may be generated within the cracker. The products of the decomposition may be useful and in particular may be useful in producing one or more of the constituents of the first and/or second injection fluids, e.g. the first fuel and/or other fluids used in the system. By way of example, the first cracker fluid may be ammonia, which may be decomposed inside the cracker into nitrogen and hydrogen. The hydrogen may be the first fuel and the nitrogen may be delivered to the combustion chamber in the secondary combustion zone. The cracker may serve as the baffle.

In some embodiments one of the chemical species is the first fuel. The first fuel of the first injection fluid may be delivered from the cracker via an outlet of the first channel and may be separated from the one or more other chemical species in an intermediate stage (e.g. a molecular sieve). A molecular sieve may be suitable for separating hydrogen and nitrogen gases decomposed in the cracker from ammonia.

In some embodiments another of the chemical species is nitrogen. This nitrogen may be delivered to the nitrogen inlet of the combustor can.

In some embodiments the cracker is further arranged to provide thermal contact between the combusting fluid in the combustion chamber and a second cracker fluid undergoing a second process passing through a second channel within the cracker to thereby increase the thermal energy of the second cracker fluid without, or substantially without altering its chemistry. It may be desirable for the second cracker fluid to have its temperature raised. The second cracker fluid may for instance be one of the first and second fuels, which may combust more readily and/or with greater efficiency if its temperature is raised. Additionally or alternatively the second cracker fluid may provide cooling to the cracker.

In some embodiments the first and second cracker fluids are of the same composition. The fluids may be derived from the same reservoir.

In some embodiments the second cracker fluid is the second fuel. The second fuel of the second injection fluid may originate from the cracker via an outlet of the second channel. The second cracker fluid may for instance be ammonia.

In some embodiments the first and second channels are arranged within the cracker such that greater heating from the fluid in the combustion chamber is experienced by the first cracker fluid than the second cracker fluid. This may for instance be achieved by positioning the first channel nearer to a hotter side of the cracker (e.g. facing the primary combustion zone) and the second channel nearer to a cooler side of the cracker (e.g. facing the secondary combustion zone) or through the use of materials having different thermal conductivity properties in association with the different passages. The differential created may facilitate the different desired levels of heating (e.g. to cause chemical decomposition of the first cracker fluid and simple heating of the second cracker fluid).

In some embodiments the system comprises a fuel heat exchanger arranged to bring into thermal contact at least part of an air flow travelling into a compressor of the gas turbine engine and a flow of the second fuel travelling for delivery in the second injection fluid by the apparatus. This may decrease the temperature of the air flow travelling into the compressor via refrigeration. Further, in this way, the second fuel may be warmed prior to combustion which may improve efficiency and/or produce a state change from a desired storage state for the second fuel (e.g. liquid) to a desired combustion state (e.g. gas). This may be completed before further warming and/or decomposition of the second fuel in the cracker. Further, the mass of the air entering the compressor may be increased by its cooling, thus potentially increasing efficiency.

In some embodiments the system comprises an exhaust fluid heat exchanger arranged to bring into thermal contact at least part of an exhaust fluid flow from the gas turbine engine and a water flow travelling for delivery to the apparatus and/or the combustion chamber. The water may for instance be converted to steam as a result of passage through the exhaust fluid heat exchanger and/or may be delivered as part of the second injection fluid to increase the mass in the combustor and/or may be introduced to the combustion chamber through one or more alternative means e.g. via an alternative port or ports (dedicated or otherwise) in the primary and/or secondary combustion zone. Additionally or alternatively, at least part of the steam may be used to pre-warm the second injection fluid via heat exchange (for instance in the apparatus) prior to the delivery of the second injection fluid by the apparatus. Additionally or alternatively, especially where there is an excess of water/steam, it may be used in district heating and/or agriculture.

In some embodiments the system comprises a condenser arranged to cool the at least part of the exhaust fluid flow from the gas turbine engine to separate water from the at least part of the exhaust fluid flow. The water may for instance be converted from steam to liquid water by the condenser, which may separate it from one or more remaining exhaust fluid constituents remaining in gaseous form. The exhaust fluid may comprise nitrogen gas, which may be exhausted to atmosphere once separated from the water by the condensation process.

In some embodiments the water flow travelling for delivery to the apparatus and/or the combustion chamber is water generated by the condenser. Additionally or alternatively at least some of the water generated by the condenser may be used for cooling the apparatus.

According to a second aspect of the invention there is provided a gas turbine engine comprising the system of the first aspect.

According to a third aspect of the invention there is provided a method of injecting fuel in a gas turbine engine optionally comprising delivering to a combustion chamber a first injection fluid optionally comprising a first fuel and a second injection fluid optionally comprising a second fuel optionally in a manner such that the first injection fluid is delivered in a first stream and the second injection fluid is delivered in a second stream and optionally such that there is a delivery zone corresponding to a first location at which both the first and second streams have been delivered optionally in which the first stream is substantially radially surrounded by the second stream.

In some embodiments, the method comprises combusting at least part of the first and/or second fuel in an initial rich combustion process and subsequently combusting at least part of the first and/or second fuel in a flameless combustion process.

In some embodiments the method comprises performing a first process comprising using heat generated by combustion of the first and/or the second fuel to heat a first cracker fluid to cause that first cracker fluid to be chemically decomposed into two or more chemical species.

In some embodiments one of the chemical species is the first fuel.

In some embodiments another of the chemical species is nitrogen.

In some embodiments the method comprises performing a second process comprising using heat generated by combustion of the first and/or second fuel to heat a second cracker fluid to thereby increase the thermal energy of the second cracker fluid without altering its chemistry.

In some embodiments the first and second cracker fluids are of the same composition.

In some embodiments the method comprises bringing into thermal contact at least part of an air flow travelling into a compressor of the gas turbine engine and a flow of the second fuel travelling for the delivery in the second injection fluid.

In some embodiments the method comprises bringing into thermal contact at least part of an exhaust fluid flow from the gas turbine engine and a water flow travelling for delivery to the combustion chamber and/or for pre-warming the second injection fluid via heat exchange prior to the delivery of the second injection fluid.

In some embodiments the method comprises condensing at least part of the exhaust fluid flow from the gas turbine engine to separate water from the at least part of the exhaust fluid flow.

In some embodiments the water flow is water generated by the condensing process.

According to a fourth aspect of the invention there is provided a gas turbine engine fluid system optionally comprising a combustion chamber and optionally a cracker optionally located within the combustion chamber, the cracker optionally being arranged to provide thermal contact between combusting fluid in the combustion chamber and a first cracker fluid optionally undergoing a first process optionally passing through a first channel within the cracker optionally to thereby chemically decompose the first cracker fluid into two or more chemical species. By positioning the cracker inside the combustion chamber, the necessary heat for the decomposition may be generated within the cracker. The products of the decomposition may be useful and in particular may be useful in producing one or more fuels or other reactants to be used in the combustor. By way of example, the first cracker fluid may be ammonia, which may be decomposed inside the cracker into nitrogen and hydrogen. The hydrogen may be used as a fuel in the combustor and/or the nitrogen may be delivered to the combustion chamber for use in cooling and or reducing reactivity in at least a part of the combustion chamber. The latter may support creation of particular forms of combustion, e.g. flameless combustion in at least part of the combustor. This may be advantageous in terms of the nature of chemical reactions occurring therein, for instance in terms of reducing undesirable emissions.

In some embodiments one of the chemical species is a first fuel for use in combustion in the combustion chamber. The first fuel of the first injection fluid may be delivered from the cracker via an outlet of the first channel and may be separated from the one or more other chemical species in an intermediate stage (e.g. a molecular sieve). A molecular sieve may be suitable for separating hydrogen and nitrogen gases decomposed in the cracker from ammonia.

In some embodiments another of the chemical species is nitrogen. This nitrogen may be delivered to a nitrogen inlet in or adjacent a secondary combustion zone of the combustor, the at least one nitrogen inlet being arranged to deliver nitrogen into the combustion chamber. The secondary combustion zone may be a flameless combustion zone which may for instance be located downstream of a primary combustion zone where rich combustion occurs. The nitrogen may assist in creating necessary or desirable conditions for flameless combustion, e.g. by reducing reactivity and/or temperature.

In some embodiments the cracker is further arranged to provide thermal contact between the combusting fluid in the combustion chamber and a second cracker fluid undergoing a second process passing through a second channel within the cracker to thereby increase the thermal energy of the second cracker fluid without altering its chemistry. It may be desirable for the second cracker fluid to have its temperature raised. The second cracker fluid may for instance be a fuel for use in the combustor, which may combust more readily and/or with greater efficiency if its temperature is raised. Additionally or alternatively the second cracker fluid may provide cooling to the cracker.

In some embodiments the first and second cracker fluids are of the same composition. The fluids may be derived from the same reservoir.

In some embodiments the second cracker fluid is a second fuel for use in combustion in the combustion chamber. The second fuel of the second injection fluid may originate from the cracker via an outlet of the second channel. The second cracker fluid may for instance be ammonia.

In some embodiments the first and second channels are arranged within the cracker such that greater heating from the fluid in the combustion chamber is experienced by the first cracker fluid than the second cracker fluid. This may for instance be achieved by positioning the first channel nearer to a hotter side of the cracker (e.g. facing a primary combustion zone where rich combustion may occur) and the second channel nearer to a cooler side of the cracker (e.g. facing the secondary combustion zone) or through the use of materials having different thermal conductivity properties in association with the different passages. The differential created may facilitate the different desired levels of heating (e.g. to cause chemical decomposition of the first cracker fluid and simple heating of the second cracker fluid).

In some embodiments the system comprises a fuel heat exchanger arranged to bring into thermal contact at least part of an air flow travelling into a compressor of the gas turbine engine and a flow of the second fuel travelling for injection into the combustion chamber. In this way second fuel may be warmed prior to combustion which may improve efficiency and/or produce a state change from a desired storage state for the second fuel (e.g. liquid) to a desired combustion state (e.g. gas). This may be completed before further warming and/or decomposition of the second fuel in the cracker. Further, the mass of the air entering the compressor may be increased by its cooling, thus potentially increasing efficiency.

In some embodiments the system comprise a fuel injection apparatus for delivering one or more fuels to the combustion chamber. The fuel delivered may the first and second fuels.

In some embodiments the system comprises an exhaust fluid heat exchanger arranged to bring into thermal contact at least part of an exhaust fluid flow from the gas turbine engine and a water flow travelling for delivery to the apparatus of the system and/or the combustion chamber. The water may for instance be converted to steam as a result of passage through the exhaust fluid heat exchanger and/or may be delivered as part of the second injection fluid to increase the mass in the combustor and/or may be introduced to the combustion chamber through one or more alternative means e.g. via an alternative port or ports (dedicated or otherwise) in the primary and/or secondary combustion zone. Additionally or alternatively, at least part of the steam may be used to pre-warm the second injection fluid via heat exchange (for instance in the apparatus) prior to the delivery of the second injection fluid by the apparatus. Additionally or alternatively, especially where there is an excess of water/steam, it may be used in district heating and/or agriculture.

In some embodiments the system comprises a condenser arranged to cool the at least part of the exhaust fluid flow from the gas turbine engine to separate water from the at least part of the exhaust fluid flow. The water may for instance be converted from steam to liquid water by the condenser, which may separate it from one or more remaining exhaust fluid constituents remaining in gaseous form. The exhaust fluid may comprise nitrogen gas, which may be exhausted to atmosphere once separated from the water by the condensation process.

In some embodiments the water flow travelling for delivery to the fuel injection apparatus and/or the combustion chamber is water generated by the condenser. Additionally or alternatively at least some of the water generated by the condenser may be used for cooling the apparatus.

In some embodiments the combustion chamber comprises a primary combustion zone in which rich combustion occurs which is downstream of the apparatus and a secondary combustion zone in which flameless combustion occurs which is downstream of the primary combustion zone. The secondary combustion zone may be immediately downstream of the primary combustion zone. The secondary combustion zone may have elevated humidity levels and/or higher fuel dilution in combustion products and/or other reaction products and/or further fluid components by comparison with the primary combustion zone. Combustion may occur in the secondary combustion zone at temperatures substantially at or below 1300K. Due to lower temperatures, flameless combustion may be conducive to reduced production of undesirable emission products, especially when burning a faster reacting fuel such as hydrogen, which may be the first fuel.

In some embodiments a combustor can of the combustor comprises at least one air inlet in or adjacent the secondary combustion zone, the at least one air inlet being arranged to deliver additional air into the combustion chamber. The at least one air inlet may be located proximate the commencement of the secondary combustion zone. The at least one air inlet may be arranged to generate axial-tangential swirl, which may promote mixing and residence time for more complete combustion as well as increasing stability. This delivery of air may facilitate dilution of the first and second fuel present in the secondary combustion zone, allowing for combustion in a discreet mode, potentially facilitating flameless combustion.

In some embodiments the combustor can comprises at least one nitrogen inlet in or adjacent the secondary combustion zone, the at least one nitrogen inlet being arranged to deliver nitrogen into the combustion chamber. The at least one nitrogen inlet may be located proximate the commencement of the secondary combustion zone. The at least one nitrogen inlet may be arranged to generate angular swirl which may promote mixing and residence time for more complete combustion as well as increasing stability. The injection of nitrogen in this manner may reduce the reactivity and temperature in the secondary combustion zone, further promoting the correct conditions for flameless combustion and/or generating more stable expansion in a turbine downstream of the combustor. The nitrogen delivered may be sourced from the cracker.

As will be appreciated, the at least one air inlet and the at least one nitrogen inlet may be a combined air and nitrogen inlet.

In some embodiments the combustion chamber comprises a baffle between the primary and secondary combustion zones which reduces the cross-sectional area of the combustion chamber and thereby creates a flow constriction for fluid passing from the primary combustion zone to the secondary combustion zone. The baffle may be substantially centrally located within the combustion chamber in a radial sense, defining a passage between the primary and secondary combustion zones around its periphery. The passage may for instance be annular. The baffle may have a prominence facing in an upstream direction which may have a central apex. The baffle may for instance be domed, be a cone, be a cone frustrum, be an ovoid or be spherical. The baffle may assist in creation of recirculation within the primary combustion zone. Specifically it may assist in turning flow travelling in a downstream direction towards the radial extremities of the combustion chamber, such that it travels upstream nearer to the centre of the combustion chamber.

According to a fifth aspect of the invention there is provided a gas turbine engine comprising the system of the fourth aspect.

According to a sixth aspect of the invention there is provided a method of performing a first process on a first cracker fluid optionally to thereby chemically decompose the first cracker fluid into two or more chemical species optionally by passing the first cracker fluid through a combustion chamber of a gas turbine engine optionally to thereby provide thermal contact between combusting fluid in the combustion chamber and the first cracker fluid.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a perspective view of a system according to an embodiment of the invention;

FIG. 2 shows a partial cut-away view of a system according to an embodiment of the invention;

FIG. 3 shows a cross-sectional view of a part of a system including a fuel injection apparatus according to an embodiment of the invention;

FIG. 4 shows a partial cut-away view of a part of a system including a cracker according to an embodiment of the invention;

FIG. 5 shows a cross-sectional view indicating fluid flow of a system according to an embodiment of the invention;

FIG. 6 shows a cross-sectional view indicating temperature profiles of a system according to an embodiment of the invention;

FIG. 7 shows a schematic view of a system according to an embodiment of the invention;

FIG. 8a shows a perspective view of a part of a system according to an embodiment of the invention; and

FIG. 8b shows a perspective view of a part of a system according to an embodiment of the invention.

### DETAILED DESCRIPTION

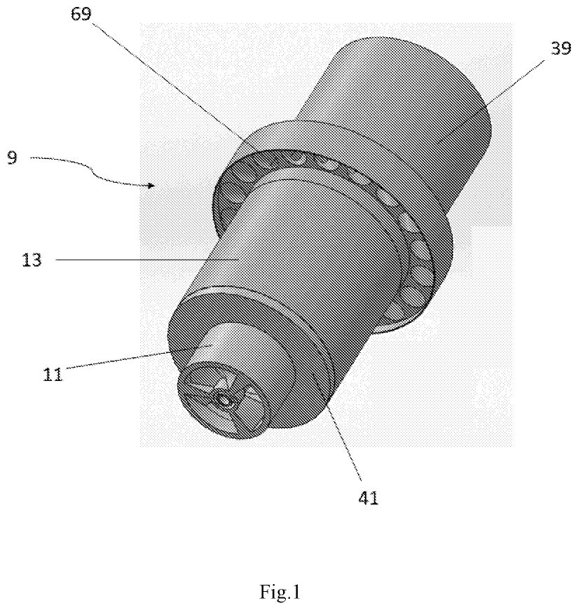

Referring first to FIGS. 1, 2 and 7, a system is generally shown at 1. The system 1 comprises a gas turbine engine generally shown at 3 and a supporting fluid processing assembly generally shown at 5. The fluid processing assembly provides fuel for the gas turbine engine 3 and manages exhaust products from the gas turbine engine 3.

The gas turbine engine 3 comprises a compressor 7, a combustor 9 and a turbine 10. As will be appreciated, depending on the particular implementation, each of the compressor 7 and turbine 10 may comprise multiple stages.

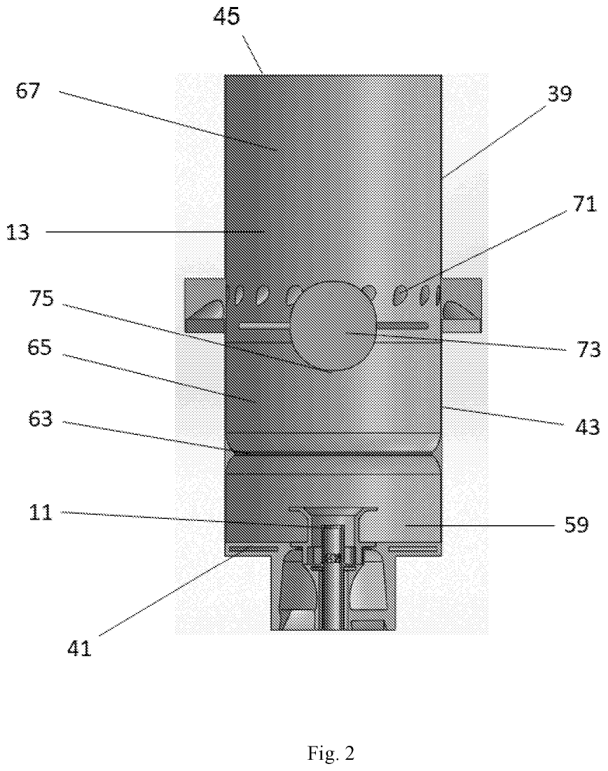

FIGS. 1 and 2 show the combustor 9. The combustor 9 has a gas turbine engine fuel injection apparatus 11 and a combustion chamber 13.

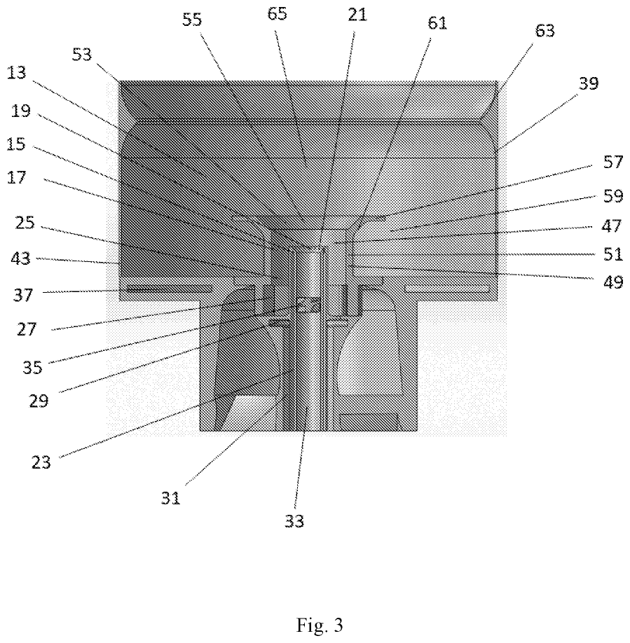

The apparatus 11 is shown in greater detail in FIG. 3. The apparatus is arranged to deliver first and second injection fluids to the combustion chamber 13, the first injection fluid in this case being a first fuel (hydrogen gas) and the second injection fluid in this case being constituted by a mixture of a second fuel (ammonia gas), a supplementary fuel (hydrogen gas), air and steam. Consequently, the first injection fluid comprises a first fuel which is a faster reacting fuel and the second injection fluid comprises a second fuel which is a slower reacting fuel and a supplementary fuel which is a faster reacting fuel.

The first and second injection fluids are delivered to the combustion chamber 13 by means of separate respective first 15 and second 17 outlets. The first outlet 15, for delivering the first injection fluid, is annular in cross-section and comprises a ring of discrete orifices. The second outlet 17, for delivering the second injection fluid, is also annular in cross-section and surrounds the first outlet 15, forming a complete ring about it. The two outlets 15, 17 are adjacent in the sense that they are proximate one another and are not separated by any other outlets or structures, other than the wall necessary to define them as separate outlets. The first 15 and second 17 outlets are concentric. Additionally, an air outlet 19, arranged to deliver air to the combustion chamber 13, is provided so as to be surrounded by the first outlet 15, the first injection outlet 15 forming a complete ring about it. The air outlet is circular in cross-section and is concentric with the first 15 and second 17 outlets. The air outlet 19 and first outlet 15 are combined in a burner head 21.

The first outlet 15, second outlet 17 and air outlet 19 are all oriented to deliver their respective fluids in a substantially axial direction, though the first outlet 15 is angled with respect to a radial plane such that it directs the flow direction of the first injection fluid so as to have a radially outward component.

The first injection fluid is delivered to the first outlet 15 by a first passage 23 of the apparatus 11. The second injection fluid is delivered to the second outlet 17 by a second passage 25, which is annular in cross-section and surrounds the first passage 23. Within the second passage 25 is an angular swirler 27, giving the second injection fluid angular swirl as it is delivered via the second outlet 17. Downstream of the angular swirler 27 and upstream of the second outlet 17, the second passage 25 has a supplementary fuel outlet 29. The supplementary fuel (in this case hydrogen) is, via the supplementary fuel outlet 29, added to the remaining constituents of the second injection fluid already flowing towards the second outlet 17 in the second passage 25. The supplementary fuel is delivered to the supplementary fuel outlet 29 in a supplementary fuel passage 31. The supplementary fuel passage 31 is annular in cross-section and provided between the first passage 23 and second passage 25, surrounding the former and surrounded by the latter. Air is delivered to the air outlet 19 by an air passage 33, which is circular in cross-section and is surrounded by the first passage 23. Additionally, the air passage comprises an axial swirler 35.

Surrounding the second passage 25 is a heating fluid chamber 37, annular in cross-section and arranged such that a heating fluid passing through the heating fluid chamber 37 is in thermal contact with the second injection fluid in the second passage 25. This may heat the second injection fluid. In this case the heating fluid is water and/or steam.

In accordance with the above, from radially inner to radially outer and in terms of principle outlets, there is disposed the air outlet 19, the first outlet 15 and the second outlet 17.

Further, from radially inner to radially outer and in terms of passages and chambers, there is disposed the air passage 33, first passage 23, supplementary fuel passage 31, second passage 25 and heating fluid chamber 37.

In the present embodiment, the combustion chamber 13 is defined by a substantially cylindrical combustor can 39, having an upstream wall 41, a side wall 43 and a downstream wall 45. Part of the apparatus 11 protrudes through the upstream wall 41 such that the first outlet 15, second outlet 17 and air outlet 19 are located axially downstream of the upstream wall 41 in the combustion chamber 13. The first outlet 15, second outlet 17 and air outlet 19 share a common central axis with the combustor can 39. Further, the first outlet 15, second outlet 17 and air outlet 19 are all substantially axially aligned (though in other embodiments they need not be). The area of the combustion chamber 13 immediately downstream of the first outlet 15, second outlet 17 and air outlet 19 (i.e. the first downstream location at which all three fluids have been delivered from their respective outlets 15, 17 and 19) is a delivery zone 47 of the combustion chamber 13. This is surrounded in a radially outward direction by a Coanda generating body 49. The Coanda generating body 49 also extends axially upstream of the outlets 15, 17 and 19 to the upstream wall 41, and downstream of the outlets 15, 17 and 19.

The Coanda generating body 49 has a cylindrical tubular portion 51 extending in the axial direction from the upstream wall 41. The tubular portion 51 extends in an axial direction beyond the outlets 15, 17 and 19. Downstream of the tubular portion 51, the Coanda generating body 49 has a flared portion 53. The flared portion 53 has a continuously tapering portion 55 and a rim portion 57. The continuously tapering portion 55 extends from the tubular portion 51 and has a cone frustum shape. The continuously tapering portion 55 has a radially inner surface with a progressively expanding cross-section in a downstream direction which meets a radially inner surface of the tubular portion 51 at an edge. In this embodiment the progressively expanding cross-section forms a slope of consistent gradient. The rim portion 57 extends from the continuously tapering portion 55 and has a downstream surface extending in a substantially radial direction. The downstream surface of the rim portion 57 and the radially inner surface of the continuously tapering portion 55 meet at an edge. Combined, the continuously tapering portion 55 and the rim portion 57 form a bell-like shape, with the radially inner surfaces of the tubular portion 51 and continuously tapering portion 55 and the downstream surface of the rim portion 51 together having a substantially convex profile.

The axial extent of the Coanda generating body downstream of the outlets 15, 17 and 19 is less than the diameter of the cylindrical tubular portion 51.

Radially outward of the Coanda generating body 49 a vortex region 59 is formed in the combustion chamber 13. The vortex region 59 is bounded radially by a radially outer surface of the Coanda generating body 49, which has a substantially concave profile, and the side wall 43 of the combustor can 39. The vortex region 59 is bounded axially by the upstream wall 41 of the combustor can 39. The remaining downstream side of the vortex region 59 is open to the remainder of the combustion chamber 13.

At least part of the upstream wall 41 of the combustor can 39 is in thermal contact with the heating fluid chamber 37 which also surrounds and is in thermal contact with the second passage 25. In this way, via the heating fluid chamber 37 and upstream wall 41, the heating fluid (e.g. water and/or steam) can also serve to cool fluids in the vortex region 59. In particular embodiments, the heating fluid may be re-circulated, exhausted or injected into the combustion chamber 13 to increase humidification in the vortex region 59 and/or further decrease the temperature of the fluids in the combustion chamber 13.

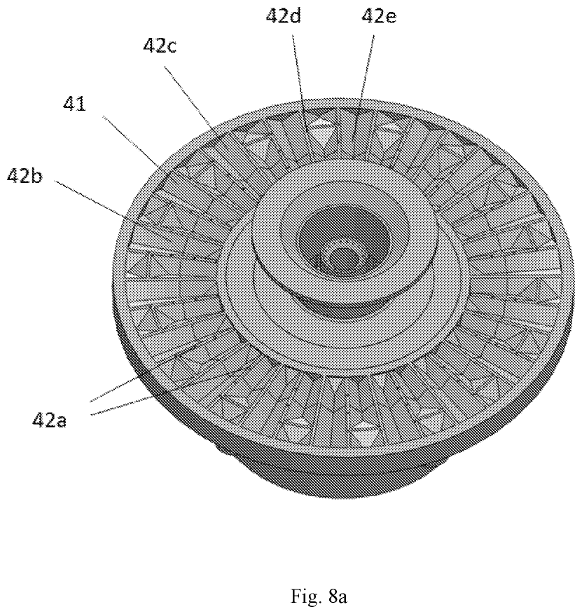

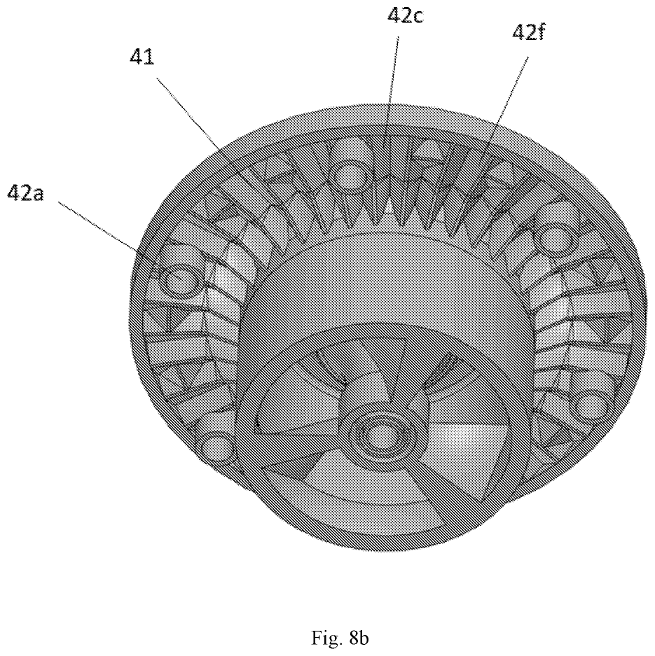

Referring now to FIGS. 8a and 8b, in the present embodiment, some of the heating fluid is injected into the combustion chamber 13, from the heating fluid chamber 37, through the upstream wall 41, via a series of ports 42a. The ports 42a are arranged to inject the heating fluid in a direction substantially perpendicular to an upstream surface 42b of the combustor can 39. The upstream surface 42b is canted with respect to the radial direction such that the upstream surface 42b moves further downstream from a radially outer to radially inner direction. The injection of the heating fluid perpendicular to this sloped upstream surface 42b may assist in forming fluid in the vortex region 59 into a vortex.

The upstream wall 41 of the combustor can 39 has a form arranged to increase its surface area by comparison with a flat plate like form. In particular, it comprises a corrugation formation 42c in its structure giving a pattern of alternating peaks 42d and troughs 42e in the circumferential direction with each peak 42d and trough 42e extending in a radial direction. This pattern is present on both the upstream surface 42b of the combustor can 39 and an opposed surface 42f facing the heating fluid chamber 37.

The combustor can 39 has a waist portion 63 in which its radially inner surface is tapered to a reduced diameter. The waist portion 63 is located in terms of its axial position so as to be substantially aligned with a ring indicating the intersection of a projection of the radially inner surface of the continuously tapering portion 55 with the side wall 43 of the combustor can 39.

The combustion chamber 13 is broadly divided into a primary combustion zone 65 corresponding substantially to its upstream half and a secondary combustion zone 67 corresponding substantially to its downstream half. The primary 65 and secondary 67 combustion zones are (in this embodiment) demarcated from one another by two features. Substantially axially aligned with the transition from the primary combustion zone 65 to the secondary combustion zone 67 is an air and nitrogen inlet 69 through the combustor can 39 side wall 43. The air and nitrogen inlet 69 comprises a plurality of ports 71 spaced regularly in an angular direction. Each port 71 is angled to generate angular swirl of the air and nitrogen mix injected. The air and nitrogen inlet 69 is fed with a supply of air from the compressor 7 via an annular duct (not shown) radially outwards of and surrounding the primary combustion zone portion of the combustion can 39.

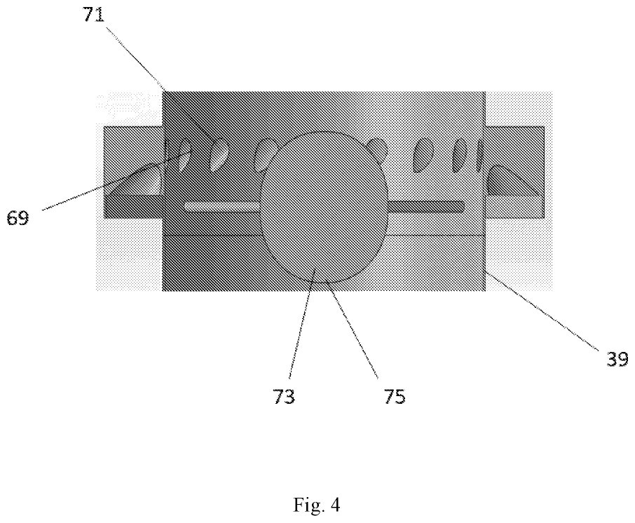

Additionally, substantially axially aligned with the transition from the primary combustion zone 65 to the secondary combustion zone 67 is a baffle 73. This can be best seen in FIGS. 2 and 4. The baffle 73 is supported in the centre of the combustion chamber 13, thereby locally reducing the cross-sectional area of the combustion chamber 13 to an annulus between the periphery of the baffle and the side wall 43 of the combustor can 39. In the present embodiment the baffle 73 is substantially ellipsoid in shape and has a prominence facing in an upstream direction having a central apex 75. In the present embodiment the baffle 73 is also a cracker. The cracker 73 has internally a first and a second channel (not shown) connected to respective inlets and outlets passing through structures supporting the cracker 73 within the combustion chamber 13. The first and second channels are located within the cracker 73 so that the first channel is nearer to an upstream end of the cracker 73 than the second channel. Because combustion is hotter in the primary combustion zone 65 than the secondary combustion zone 67, a first cracker fluid passing through the first channel is heated to a greater extent (e.g. to approximately 700° C.) than a second cracker fluid passing through the second channel (e.g. approximately 400° C.). In the present embodiment the first and second cracker fluids are the same, ammonia. In the first channel the ammonia is chemically decomposed into hydrogen gas (the first fuel) and nitrogen gas. In the second channel the ammonia is not chemically decomposed but is instead heated.

The outlet of the first channel leads to a molecular sieve (not shown) for separating chemical species (in this case separating the hydrogen gas from the nitrogen gas). From the molecular sieve, separated hydrogen is ducted to the first passage 23 and supplementary fuel passage 31. The nitrogen gas separated by the molecular sieve is ducted to the air and nitrogen inlet 69 for mixing with air and injecting into the secondary combustion zone 67.

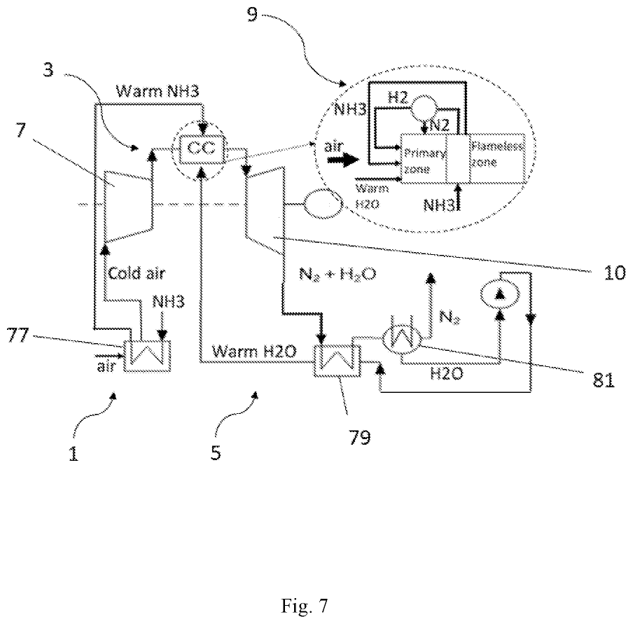

The outlet of the second channel leads to the second passage 25 for delivering the heated ammonia for use as the second fuel in the second injection fluid. The inlet to the second channel receives its ammonia from a fuel heat exchanger 77 (see FIG. 7). The fuel heat exchanger 77 receives its ammonia supply from a fuel tank (not shown), and brings that ammonia into thermal contact with at least part of an air flow travelling into the compressor 7 of the gas turbine engine 3. It is the ammonia warmed by its passage through the fuel heat exchanger 77 that is delivered to the inlet to the second channel of the cracker 73. Further, the expansion of the liquid ammonia to gas ammonia provides cooling to the air flow travelling into the compressor 7.

Further fluid processing is performed by an exhaust fluid heat exchanger 79 (see FIG. 7). Steam and nitrogen are generated in the combustion process and are collected from the exhaust of the gas turbine engine 3. At least part of this exhaust fluid flow is brought into thermal contact with a water flow. The water flow is being delivered to the second passage for use as a constituent in the second injection fluid and to the heating fluid chamber 37 for heating the second injection fluid in the second passage 25, cooling the fluids in the combustion chamber 13 and delivery into the vortex region 59 for cooling and diluting purposes. The water flow is itself derived from the exhaust fluid flow. Once the exhaust fluid flow has passed through the exhaust fluid heat exchanger 79, it passes through a condenser 81. In the condenser 81, the water in the exhaust fluid is separated from the nitrogen also therein. The nitrogen is exhausted to atmosphere whilst the water is delivered to the exhaust fluid heat exchanger 79. The water will also dilute any remaining NOx and unburned ammonia emission product of the combustion process.

In use of the system 1, liquid ammonia fuel, which is the second fuel, is pumped from the fuel tank to the fuel heat exchanger 77, where it undergoes heat exchange with at least part of the air flow passing into the compressor 7. This heat exchange increases the thermal energy of the ammonia for greater combustion efficiency. It also changes the state of the ammonia from liquid as stored to gas. and cools the air flow travelling into the compressor, for greater mass of air passing through the gas turbine engine 3. Thereafter, a portion of the ammonia is pumped through the second channel of the cracker 73. In the second channel, as the second cracker fluid, the ammonia undergoes the second process of having its thermal energy further increased via heat exchange with the combusting fluid in the combustion chamber 13. Thereafter it is pumped to the second passage 25 as the second fuel and for ultimate delivery as a constituent of the second injection fluid.

Meanwhile, another portion of the ammonia fuel from the fuel heat exchanger 77 is passed through the first channel of the cracker 73. There, as the first cracker fluid, the ammonia undergoes the first process of chemical decomposition, resulting from heat exchange with the combusting fluid in the combustion chamber 13, into the two chemical species hydrogen and nitrogen. Thereafter, the hydrogen and nitrogen is pumped through a molecular sieve, separating the hydrogen and nitrogen. The hydrogen, which is the first fuel, is pumped to the first passage 23 for use as the first injection fluid and to the supplementary fuel passage 31 for use as the supplementary fuel. Thus, the first fuel is generated by the system 1 from the second fuel. The nitrogen is pumped to the air and nitrogen inlet 69.

Within the apparatus 11, the first fuel i.e. hydrogen gas, which in this embodiment constitutes the first injection fluid, is pumped through the first passage 23 and out of the first outlet 15 at the burner head 21. At the point of its delivery, the hydrogen injected by the first outlet 15 is delivered in a first stream of annular cross-section, travelling in a substantially axial downstream direction, though with some radially outward component imparted by the angling of the first outlet 15 with respect to a radial plane. As the first stream is delivered it is partially combined with swirling air simultaneously delivered from the air outlet 19, also in the burner head 21. Air delivered from the air outlet 21 is delivered to the air outlet by the compressor 7 and passes through the air passage 33 and its axial swirler 35.

Within the apparatus 11, the second fuel, i.e. ammonia gas, in the second passage 25 is mixed with air delivered to the second passage 25 by the compressor 7 and with water and/or steam injected into the second passage 25 from the heated water coming from the exhaust fluid heat exchanger 79 via the heating fluid chamber 37. This mix is passed through part of the second passage 25 having the angular swirler 27. Thereafter, hydrogen gas is introduced to the second passage 25 by the supplementary fuel passage 31 and supplementary fuel outlet 29, and is thereby mixed with the ammonia, air and steam already in the second passage. The resulting mix constitutes the second injection fluid and this is pumped through the second outlet 17. At the point of its delivery, the second injection fluid injected by the second outlet 17 is delivered in a second stream of annular cross-section, travelling in a substantially axial downstream direction. The second stream substantially surrounds the first stream as the two streams are delivered into the delivery zone 47. Thus, if travelling in a radially outward direction from substantially any part of the first stream, the second stream is encountered. It should be noted that in this embodiment, in addition to water and/or steam from the exhaust fluid heat exchanger 79 being injected into the second passage 25, it is also injected separately and directly into the vortex region 59 via the ports 42a, but in other embodiments, only one, other or neither of these may occur.

The quantities of the constituents of the first and second injection fluids and the quantity of any water and/or steam injected directly into the vortex region 59 may be selected such that the total steam volume injected is between 0%-40% of the total fuel volume injected (that is fuel and steam are injected in a ratio of fuel 5:2 steam or in some higher ratio of fuel to steam).

Once delivered to the delivery zone 47, the first stream is ignited by an ignitor (not shown). The effect of the axial swirler 35 on the air delivered from the air outlet 21 gives the ignited hydrogen a swirling flame, which in turn may give rise to recirculation in the vicinity of the delivery zone 47 via vortex breakdown. The hydrogen of the first stream is ignited readily, but the ammonia of the second stream ignites less readily. The ignited hydrogen of the first stream serves as a pilot for ignition of the ammonia of the second stream. The hydrogen of the first stream therefore serves a useful purpose in igniting the ammonia of the second stream, but its combustion mechanism at this hot early stage of the combustion process produces nitrogen oxides which are undesirable from an emissions stand-point (i.e. (H₂+(O₂+N₂ (air))=>NOx+H₂O). However, unburned ammonia and ammonia radicals (e.g. NH₂) in the second stream can reduce the nitrogen oxides back into nitrogen (i.e. NH 3+NOx=>N₂+H₂O) where combustion temperature condition are between approximately 1200-1600K and with ammonia concentrations at approximately 30-40%. Because the first stream is surrounded by the second stream as the streams enter the delivery zone 47 and enter the primary combustion zone 65, nitrogen oxides produced in combustion of the hydrogen of the first fuel and the ammonia of the second fuel may be more likely to encounter unburned ammonia and ammonia radicals of the second fuel and therefore to reduced. The first stream having a component of its travel direction towards the second stream (as a result of the angling of the first outlet 15) may also increase this likelihood. The recirculation occurring in the proximity of the delivery zone 47 as a result of the axial swirler 35 may increase residency time and therefore an increased proportion of the delivered hydrogen being burned at this stage to produce nitrogen oxides. Burning a greater proportion of the hydrogen at this stage may be advantageous in view of the nitrogen oxides produced having a greater likelihood of encountering unburned ammonia and ammonia radicals of the second fuel in the surrounding second stream (i.e. due to the surrounding second stream and direction of travel of the first stream). Furthermore, because the second injection fluid (and therefore the ammonia of the second fuel) is, by virtue of it being delivered radially outwards of the first injection fluid, somewhat shielded/removed from the core of the combusting flame and therefore the hottest temperatures, additional ammonia may be preserved unburnt. This may then be available for reducing nitrogen oxides.

As the first and second streams travel downstream, they encounter sequentially two distinct low pressure zones in a radially outward direction generated respectively by the continuously tapering portion 55 and the rim portion 57 of the Coanda generating body. These tend to increase the component of the travel direction of the fluids in the radially outwards direction, bending and to some extent flattening the flame. This may tend to reduce somewhat the temperature at the burner head 21, reducing its stress and potentially reducing its maintenance/replacement needs. As will be appreciated, the separate first and second streams will gradually lose their identities and at least to some extent will intermix to give rise to a more general mix of combusting fluid and other reactants and constituents. The combusting fluid continues travelling downstream and radially outward. The combination of the initial effect of the Coanda generating body 49 in bending the flame, the waist portion 63, side wall 43 and upstream wall 41 of the combustor can 39 and radially outer surface 61 of the Coanda generating body 49 tend to cause the formation of a trapped vortex of the mix of fluids in the vortex region 59. Additionally, the combination of the initial effect of the Coanda generating body 49 in bending the flame, the waist portion 63, side wall 43 of the combustor can 39 and partial blocking of the exit from the primary combustion zone 65 by the cracker 73, tend to cause the formation of a larger central re-circulation. This may substantially fill the remainder of the primary combustion zone 65 with post-combustion, hot radicals in an oxygen depleted area, thus promoting reduction of nitrogen oxides still further.

The formation of a trapped vortex in the vortex region 59 may be further encouraged both by the corrugation formation 42c (which may tend to channel fluid in a substantially radial direction), and water and/or steam injected via the ports 42a (the direction of injection having radially inward and downstream components).

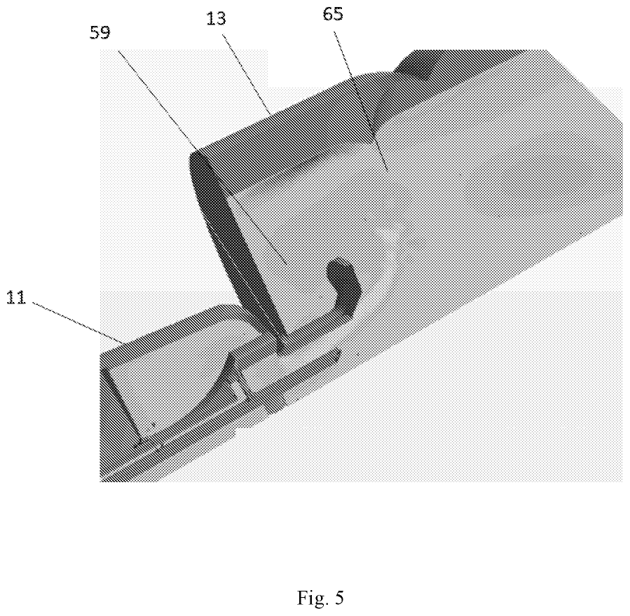

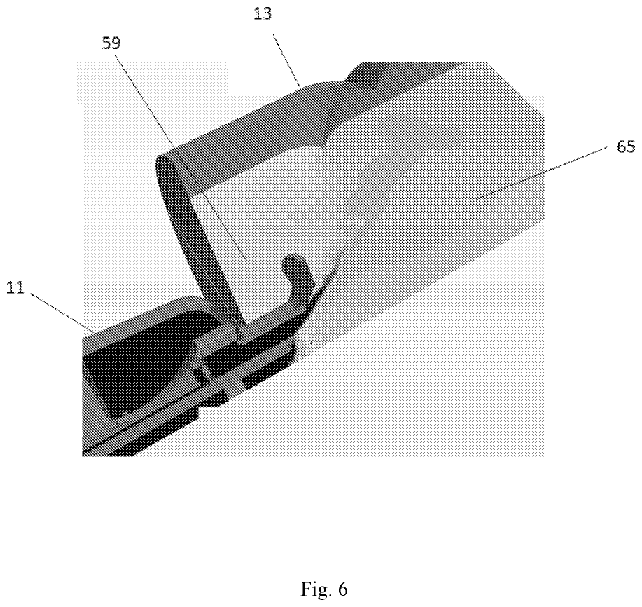

The bending effect of the Coanda generating body 49 can be seen in FIG. 5 and the initial stages of formation of the trapped vortex and larger central recirculation can be seen in FIG. 6. Both the trapped vortex and larger central recirculation increase the residence time of the fluids in the combustion chamber 13 and in particular, in the primary combustion zone 65. This gives rise to additional mixing to encourage, and allows more time for, the reduction of nitrogen oxides by traces of unburned ammonia and unreacted ammonia radicals. Additionally, the trapped vortex, water temperature control and central recirculation somewhat reduce the temperature in the primary combustion zone 65, which may give rise to temperatures better suited to this reduction (i.e. within the range 1200-1500K). The steam component of the second injection fluid may also assist with temperature reduction as well as increasing the mass of the fluids and therefore the power generated. As the re-circulation occurs, the presence of hydrogen within the second injection fluid may assist in continued ignition of unburned ammonia.

Also assisting in reducing the temperature of the fluids in the combustion chamber 13 is water and/or steam injected through the ports 42a from the heating fluid chamber 37 as well as the corrugation formation 42c increasing heat exchange with the water and/or steam in the heating fluid chamber 37.

Eventually, the mix of fluids, now with a significant proportion of the hydrogen and ammonia combusted, and diluted by significant water and nitrogen components, passes through the annulus between the periphery of the cracker 73 and the side wall 43 of the combustor can 39. It thus enters the secondary combustion zone 67. As the mix of fluids pass the cracker 73, they heat the cracker 73, thereby allowing it to function as previously described, facilitating heat exchange with the fluids in its first and second channels.

In order to provide additional air for combustion and to further dilute the mix of fluids in order to create the desired combustion conditions (discussed further below), air and nitrogen are injected via the plurality of ports 71 at the upstream end of the secondary combustion zone. Additionally, swirl imparted by the nature of the plurality of ports 71 assists in increasing mixing and residency within the secondary combustion zone 67.

As noted previously, combustion of hydrogen at relatively high temperatures gives rise to undesirable nitrogen oxides. Once therefore sufficient hydrogen has been combusted within the hotter primary combustion zone 65 to adequately ignite the ammonia of the second injection fluid, it is preferable that any remaining hydrogen is predominantly combusted in another manner. Furthermore, it is known that ammonia combustion under rich conditions also leads to hydrogen production and this hydrogen will in general not combust in the primary zone due to a lack of oxygen. For pure hydrogen, it is desirable for the combustion to occur below approximately 1200-1300K, for reduction of nitrogen oxide formation. This may be achieved in the secondary combustion zone 67, where flameless combustion occurs. In flameless combustion, no flame is present and the combustion of the hydrogen occurs in a discrete mode. This may occur with sufficiently diluted reactants (e.g. hydrogen and oxygen diluted in water and nitrogen) and sufficiently reduced temperature. That is, whilst hydrogen and oxygen molecules are present to react, they are sufficiently diluted such that insufficient reaction occur per unit volume to produce a visible flame. Such conditions may prevail in the secondary combustion zone 67, due to a number of factors. First, most hydrogen will have already been combusted in the primary combustion zone 65. Second, combustion in the primary combustion zone 65 produces diluting agents (mainly water and nitrogen) and the increased residence time in the primary combustion zone 65 will increase the production of these diluting agents, increasing mixing and allowing for reductions in temperature. Water and nitrogen may comprise more than 90% of the material reaching the secondary combustion zone 65 and may comprise more than 95%. Third, injection of the nitrogen via the plurality of ports 71 will further dilute the reactants for delivery to the secondary combustion zone 67. It is to be further noted that the location of the first outlet 15 (i.e. at a more radially inward/central position), may result in the hydrogen of the first injection fluid tending to be recirculated less in the primary combustion zone 65 than the constituents of the second injection fluid, instead tending to follow a more direct path to the secondary combustion zone 67. This may be beneficial in that less of the hydrogen may be combusted in the primary combustion zone 65 and more in the secondary combustion zone 67.

Exhausted from the secondary combustion zone 67 are the combustion products. The exhaust fluid flow will be predominantly water and nitrogen. The water component may be approximately 30%-40%. This may be contrasted with traditional gas turbine engines running on conventional fossil fuels where water concentration may be less than approximately 10%. Once they have passed through the turbine 10, the exhaust products are ducted to the exhaust fluid heat exchanger 79. In the exhaust fluid heat exchanger 79, thermal energy from the exhaust fluid flow is transferred to a water flow (increasing the temperature of the water). The water flow is pumped to the heating fluid chamber 37 for heating the second injection fluid in the second passage 25 and controlling temperatures in the vortex region 59. Part of it is then injected into the vortex region 59 via the ports 42a, whilst the remainder is pumped to the second passage 25 for use as a constituent in the second injection fluid. Water for the water flow is derived from the exhaust fluid flow. Once the exhaust fluid flow has passed through the exhaust fluid heat exchanger 79, the fluid then passes through the condenser 81. In the condenser 81, the water in the exhaust fluid is separated from the nitrogen also therein. The nitrogen is exhausted to atmosphere whist the water is pumped to the exhaust fluid heat exchanger 79.

The system 1 thus generates its own fuels and reactants from a single fuel input and utilises part of the thermal energy and some of the exhaust products it generates.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims. By way of example, an embodiment of the system comprising the cracker and an associated combustion chamber may be used independently of the remainder of the system discussed in the embodiment above and/or in association with other system features. For instance, an embodiment of the system comprising the cracker and an associated combustion chamber may be used in association with a different gas turbine engine, which might for instance differ in the fuels used and/or their manner of delivery. By way of a further example, in the embodiment described above, steam is injected as part of the second injection fluid and through the upstream wall 41 of the combustor can 39, though in other embodiments only one, other or neither of these may occur.

1. A system comprising:
a fuel injection apparatus arranged to deliver to a combustion chamber a first injection fluid comprising a first fuel and a second injection fluid comprising a second fuel, the fuel injection apparatus being arranged to deliver the first and second injection fluids in a manner such that the first injection fluid is delivered in a first stream and the second injection fluid is delivered in a second stream and such that there is a delivery zone corresponding to a first location at which both the first and second streams have been delivered in which the first stream is substantially radially surrounded by the second stream.

2. The system according to claim 1, wherein the fuel injection apparatus is arranged to deliver the first and second streams in substantially a same direction.

3. The system according to claim 1, wherein the first and second streams are delivered from separate respective first and second outlets.

4. The system according to claim 3, further comprising:
an air outlet, radially inward of and radially surrounded by the first outlet, arranged to deliver air for combustion with the first and second fuels once delivered.

5. The system according to claim 1, wherein initial combustion of at least part of the first injection fluid in the first stream serves as a pilot for ignition of at least part of the second injection fluid in the second stream.

6. The system according to claim 1, wherein the first fuel comprises a faster reacting fuel and the second fuel comprises a slower reacting fuel.

7. The system according to claim 1, wherein the delivery zone is radially surrounded and defined by a Coanda generating body into which the first and second injection fluids are delivered by the fuel injection apparatus.

8. The system according to claim 7, wherein the Coanda generating body comprises a tubular portion radially surrounding the fuel injection apparatus having a radially inner surface of consistent cross-section and connected thereto a flared portion downstream of the tubular portion.

9. The system according to claim 8, wherein the radially inner surface of the tubular portion and a radially inner surface of a continuously tapering portion of the flared portion meet at a discontinuity in a form of an edge.

10. The system according to claim 9, wherein
the flared portion comprises a rim portion connected to the continuously tapering portion having a downstream surface extending in a substantially radial direction.

11. The system according to claim 10, wherein the radially inner surface of the continuously tapering portion and the downstream surface of the rim portion meet at a discontinuity in a form of an edge.

12. The system according to claim 7, wherein the Coanda generating body extends into a combustion chamber defined by a combustor can, forming a vortex region bounded radially by a radially outer surface of the Coanda generating body and a radially inner surface of the combustor can and bounded axially by an upstream surface of the combustor can.

13. The system according to claim 12, wherein the combustion chamber comprises a primary combustion zone in which rich combustion occurs which is downstream of the fuel injection apparatus and a secondary combustion zone in which flameless combustion occurs which is downstream of the primary combustion zone.

14. The system according to claim 13, wherein the combustor can comprises at least one air inlet in or adjacent the secondary combustion zone, the at least one air inlet being arranged to deliver additional air into the combustion chamber.

15. The system according to claim 12, wherein a cracker is located within the combustion chamber and is arranged to provide thermal contact between combusting fluid in the combustion chamber and a first cracker fluid undergoing a first process passing through a first channel within the cracker to thereby chemically decompose the first cracker fluid into two or more chemical species.

16. The system according to claim 15, wherein one of the two or more chemical species is the first fuel.

17. The system according to claim 15, wherein cracker is further arranged to provide thermal contact between the combusting fluid in the combustion chamber and a second cracker fluid undergoing a second process passing through a second channel within the cracker to thereby increase a thermal energy of the second cracker fluid without altering its chemistry.

18. The system according to claim 17, wherein the second cracker fluid is the second fuel.

19-21. (canceled)

22. A method of injecting fuel, comprising:
delivering to a combustion chamber a first injection fluid comprising a first fuel and a second injection fluid comprising a second fuel in a manner such that the first injection fluid is delivered in a first stream and the second injection fluid is delivered in a second stream and such that there is a delivery zone corresponding to a first location at which both the first and second streams have been delivered in which the first stream is substantially radially surrounded by the second stream.

23. A fluid system, comprising:
a combustion chamber; and
a cracker located within the combustion chamber, the cracker being arranged to provide thermal contact between combusting fluid in the combustion chamber and a first cracker fluid undergoing a first process passing through a first channel within the cracker to thereby chemically decompose the first cracker fluid into two or more chemical species.

24-25. (canceled)
